(19) United States
(12) Patent Application Publication
(10) Pub. No.: US 2011/0048657 A1
(43) Pub. Date: Mar. 3, 2011

(54) WINDOW CURTAIN SAFETY DESIGN

(76) Inventors: Cheng-Tsung Tung, Nantou City (TW); Hsien-Te Huang, Nantou City (TW)

(21) Appl. No.: 12/571,807

(22) Filed: Oct. 1, 2009

(30) Foreign Application Priority Data
Aug. 31, 2009 (TW) 098129310

(51) Int. Cl. E06B 9/80

(52) U.S. Cl. 160/319

(57) ABSTRACT

A window curtain safety design, having particular use in a window curtain set which utilizes a looping pull cord that can be pulled single-handed to alter shading condition of a window curtain, and which provides a safety design preventing the dangling closed end of the pull cord from accidentally entangling the limbs. The present invention provides a roll-up control unit, and when the roll-up control unit is subjected to inappropriate excessive pulling forces from two sides of a pulling component (pull cord), then essential components within the roll-up control unit form an opening operation, which causes the entire length of the pulling component to separate and form a separated free state which releases the binding forces at the lower end of the pulling component, thereby achieving the objective of maintaining safety of the limbs.

### BACKGROUND OF THE INVENTION

(a) Field of the Invention

The present invention relates to a window curtain safety design, and more particularly to a window curtain safety design for use in a window curtain set which uses a looping pull cord that can be pulled single-handed to alter the shading condition of a curtain. Moreover, when inappropriate forces are applied to a pull cord of a roll-up control unit, then separation between combined essential components of the roll-up control unit is made to occur, which prevents limbs from being entangled by the dangling closed end of the pull cord, and thereby achieves the objective of maintaining safety of limbs. After separation, the components can be reused after recombination thereof.

(b) Description of the Prior Art

In order for the window opening of a window to cut off the quantity of light from external light rays entering a room, curtains are used to cut off the light, and circumstances regarding the quantity of light entering a window regulate the need to adjust the window curtains. A common adjustment method is to use cords which a user can operate single-handed by pulling. In order for the cords to be able to fulfill the requirements for relatively long up-down distances of travel, a roll-up configuration is adopted whereby a multiple looping roll-up machine assembly is used to roll up and release the curtains. Moreover, the configuration is at the upper end with the machine assembly fixed to the position of the upper curtain rod of the curtains, and the lower dangling end forms a loop type closed end, with the dangling end being able to be conveniently pulled using the hands. Hence, when the dangling end is at a height close to that of the waist of an adult, then it can be easily grasped and played with by young children, creating the danger of entangling the limbs of young children, and the danger of the child being hung.

Regarding window curtains provided with pull cords of the prior art, please refer to FIGS. 1 and 2, wherein a window curtain set 10 indirectly drives a roller 106 through two side fixing mounts 103 via a driving unit 101. The driving unit 101 is fitted with a roll-up control wheel 104, and the roll-up control wheel 104 is controlled through a pull cord 102. The motive force produced by the pull cord 102 is transmitted to a transmission shaft 105, whereupon the roller 106 is actuated, and rolling up and letting down of the roller 106 enables altering the sunshade area of the window curtain. The window curtain set 10 is fixed to a wall surface, and the driving unit 101 is actuated by pulling on the pull cord 102, the pull cord 102 being similarly fixedly positioned to a wall surface. Dangling ends of the pull cord 102 are formed as a looped closed end, thus, creating the danger of inadvertently entangling limbs 107 of young children when playing.

In order to maintain the safety of children under the aforementioned circumstances, Taiwan businesses proposed a design to resolve such a problem using a magnetic disengagement device indirectly connected at a disconnecting position of the pull cord, which causes magnetic separation thereof to occur under circumstances whereby when the pull cord is being played with by children and entangles the limbs of a child producing inappropriate forces, thereby achieving effective safety protection, and providing a positive safeguarding method. However, such a method cannot be used in window curtain sets having looping pull cord specifications.

In order to be able to fulfill the requirements for relatively long up-down distances of travel of a curtain, the pull cord is configured to effect a continuous looping movement, and the pull cord is used to drive a curtain through a roll-up control machine assembly of wheel bodies. Structural constraints impose miniaturization of diameters of the wheel bodies, and unless there is sufficient space to additionally install a speed variator, otherwise turn around speed of the wheel bodies is limited to mini proportional linear displacement length by the pull cord. For example, if the looping pull cord is pulled through one loop, then transmission ratio of the wheel bodies is 1:10, and turnaround of ten loops is only able to drive and displace a curtain one meter. If height of the window opening of the window is two meters, then the pull cord must be pulled through two loops before fulfilling the length of distance the curtain must travel, thus, unimpeded looping movement of the pull cord must be satisfied. Hence, according to the aforementioned magnetic separating design, movement of the pull cord is limited to within one loop, and is unable to satisfy adjustment through the travel depth of large-scale window curtains.

### SUMMARY OF THE INVENTION

The present invention provides a window curtain safety design, and more particularly provides a window curtain safety design for use in a window curtain set which uses a looping pulling component (pull cord) to alter the shading condition of a curtain, and which prevents the dangling closed end of a pulling component from entangling the limbs. The present invention primarily uses components within a roll-up control unit, in which under circumstances whereby when inappropriate forces are applied to the pulling component that is able to effect a looping roll-up operation, then essential components form an opening operation, which causes the entire length of the pulling component to maintain a looping separated free state, thereby achieving the objective of maintaining safety of the limbs.

A second objective of the present invention is to use a roll-up control wheel located within the roll-up control unit that is supported and fixedly positioned by an elastic force, and the roll-up control wheel is controlled by the pulling component. When there is inappropriate synchronous excessive pulling on two sides of the looping pulling component, then a counter force produced compensates the aforementioned elastic supporting force, after which deformation occurs causing opening of the positions of the combined components, thereby separating and freeing the pulling component, and releasing the entangling force of the closed end on the limbs, thus achieving the objective of maintaining safety of the limbs.

A third objective of the present invention is to provide the roll-up control unit with a mount, and a plate of the roll-up control wheel is elastic deformable, thereby enabling displacement of component positions from the combination specifications of the roll-up control wheel, and allowing slippage of the pulling component.

A fourth objective of the present invention is to structure the roll-up control unit from the roll-up control wheel pin disposed on the mount, in which the roll-up control wheel is supported by at least one elastic deformable pin connected plate, and under circumstances whereby the roll-up control wheel is subjected to extraneous inappropriate forces from the pulling component, then the pin connected plate deforms causing the roll-up control wheel to disengage from a shaft, thereby enabling dislodgement and freeing of the pulling component.

A fifth objective of the present invention lies in: after the roll-up control unit is subjected to inappropriate forces, then the pulling component is caused to form a separated state, and such a state is able to prompt a guardian of the situation that has occurred, thereby reminding the guardian to reinforce safety education of young children or those unaware of the dangers, and thus maintaining the safety of young children.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a structural view of a traditional window curtain set.

FIG. 2 is a schematic view depicting the danger of the traditional window curtain set.

FIG. 3 is a schematic view of an embodiment of a safety device according to the present invention.

FIG. 4 is a schematic view depicting a first embodiment of a roll-up control unit of the present invention.

FIG. 5 is a schematic view depicting a safety aspect of FIG. 4 according to the present invention.

FIG. 6 is a schematic view depicting a second embodiment of a roll-up control unit of the present invention.

FIG. 7 is a side view of FIG. 6 according to the present invention.

FIG. 8 is a schematic view depicting a safety aspect of the second embodiment according to the present invention.

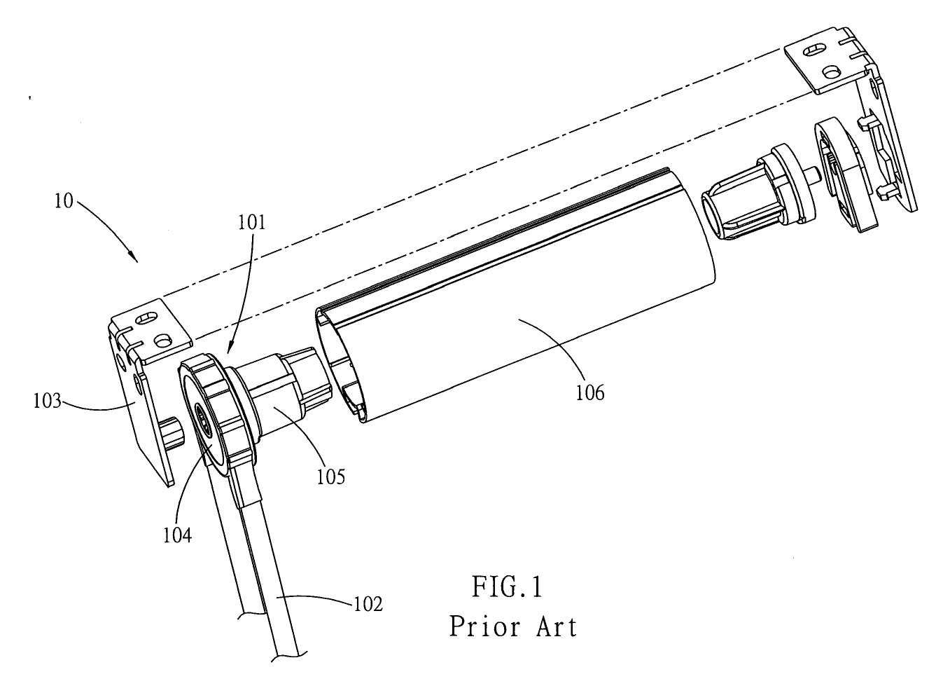

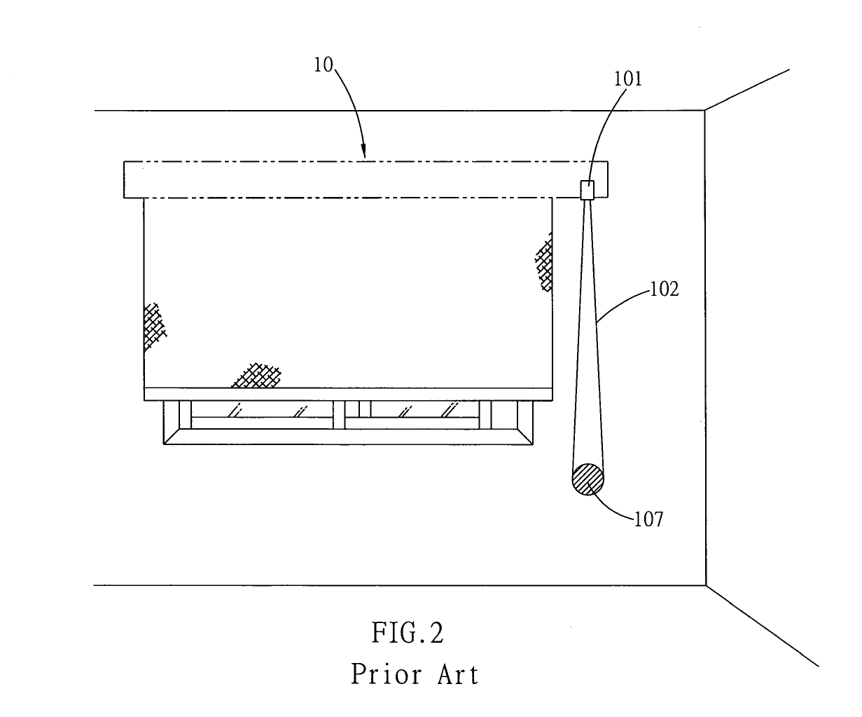

### DETAILED DESCRIPTION OF THE PREFERRED EMBODIMENTS

The present invention provides a window curtain safety design, which has particular use in a window curtain set employing roll-up control of a looping pull cord to vary the shading condition of the curtain, having the ability to prevent the dangling closed end of the pull cord from accidentally entangling the body of someone. The primary function of the present invention is to guard against the danger of the limbs of young children becoming entangled in a pulling component (pull cord) when playing, thereby achieving the objective of maintaining personal safety.

A roll-up control unit of the present invention is controlled through a pulling component, and the motive force output therefrom actuates the curtains of a window curtains set to vary light shading depth. The present invention primarily uses a deformation portion located at a component position joined to the roll-up control unit corresponding to the pulling component, accordingly, under circumstances whereby the pulling component is subjected to inappropriate forces, then deformation of the deformation portion is used to change the combination space and cause essential components to open, thereby separating and freeing the pulling component, as well as releasing the pulling force of the corresponding dangling end.

The deformation portion of the roll-up control unit is formed with elastic recovery ability, thereby enabling reuse after recombination of the components.

The roll-up control unit comprises a mount, one side of which is fitted with a transmission shaft, and the transmission shaft is linked to a roll-up control wheel, the roll-up control wheel being controlled by pulling on the looping pulling component. One side of the mount is the deformation portion, and the deformation portion is fabricated from a deformable plate. When the roll-up control wheel is subjected to inappropriate forces from the pulling component, then one end of a wheel shaft produces a leverage effect, thereby causing curved deformation of the plate. Accordingly, deformation of the plate is used to enable the pulling component to jump the wheel face of the roll-up control wheel and become free.

Regarding another specific embodiment enabling the pulling component to separate from the roll-up control unit, the pulling component together with connected components thereto are caused to synchronously separate from the roll-up control unit. And the actuating mechanism that releases the dependently connected roll-up control wheel together with the pulling component to enable separation from the roll-up control unit comprises the at least one deformable pin connected plate of the mount of the roll-up control unit located at a pin connected position of the roll-up control wheel, with the pin connected plate being provided with shaft holes which enable the wheel shaft of the roll-up control wheel to be pin disposed therein. Under circumstances whereby when the roll-up control wheel is subjected to inappropriate forces, then the pin connected plate deforms to yield the wheel shaft from spanning the length of the two ends of the roll-up control wheel, thereby releasing the wheel shaft which together with the pulling component separates from the roll-up control unit.

In addition, the pin connected plate is provided with elastic recovery, thereby enabling reuse after recombination of the components.

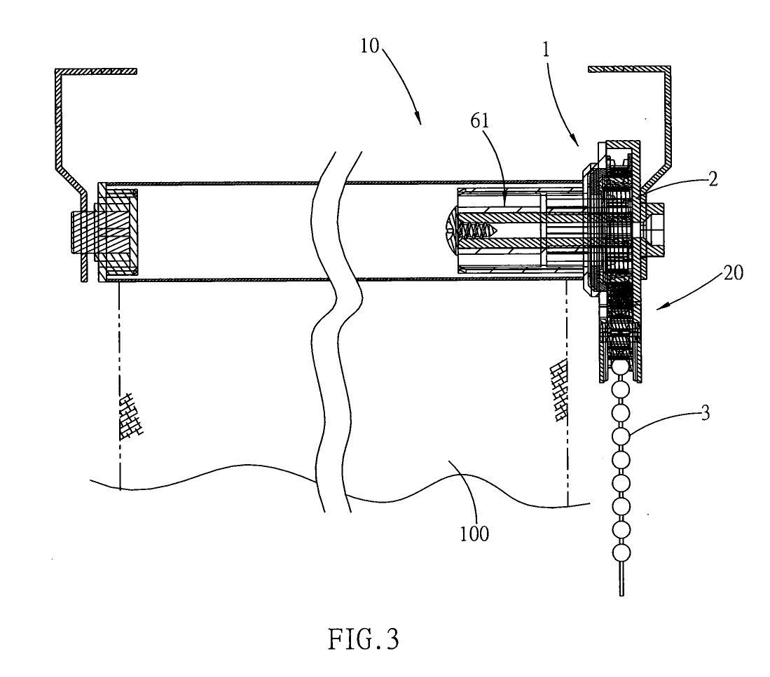

Regarding the safety operation of the present invention, as mentioned above, should the pulling component entangle the feet and limbs of an unknowing child when playing, and the struggling movements of the child produce extraneous forces on the pulling component, then, during the process of transmitting and inconsequentially imposing on the roll-up control unit, essential components of the roll-Up control unit open, thereby freeing the pulling component and surrendering the entangling forces on the limbs. Regarding the operational design and principle thereof of the corresponding operations, please refer to the attached drawings and description hereinafter. Referring first to FIG. 3:

A roll-up control unit 1 of the present invention is controlled by pulling on a pulling component 3, and pulling on the pulling component 3 causes a transmission shaft 61 fitted to the roll-up control unit 1 to output power that drives a curtain 100 of a window curtain set 10, thereby altering the shading depth of a window. The configuration primarily uses a deformation portion 20 connectively located to a component position relative to the pulling component 3 of the roll-up control unit 1. Under circumstances whereby when the pulling component 3 is subjected to inappropriate forces (inappropriate forces being defined here as forces produced by body weight multiplied by gravity or mass multiplied by acceleration caused by a child struggling to free his limbs when the closed end of the lower portion of the pulling component 3 entangles the limbs of a young child when playing, or the limbs become suspended by the pulling component 3), then deformation of the deformation portion 20 is used to deform the combination space, thereby causing essential components to open, separating and freeing the pulling component 3 from the roll-up control unit 1 and releasing the pulling force of the dangling end, thus providing a safety function that prevents limbs from being entangled.

The deformation portion 20 of the roll-up control unit 1 is formed with elastic recovery ability, thereby enabling reuse after recombination of the components, while the open state prior to recombination can prompt adults of what has occurred and enable them to reinforce safety education and psychological counseling of young children. Hence, the open state of the components of the present invention provides guardians with explicit information, which is able to prompt guardians of the need for safety education of young children, and more commendable is the design of the present invention, which is able to effectively maintaining the life safety of young children.

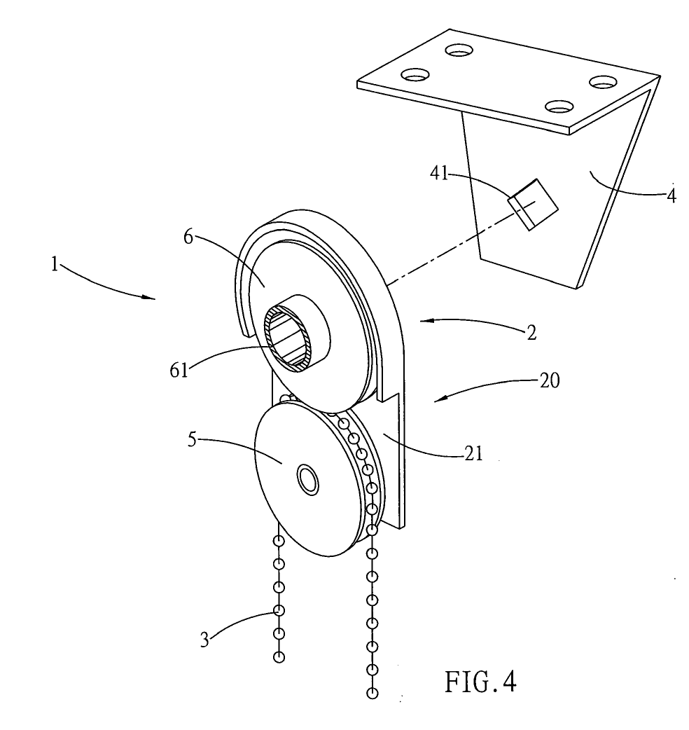

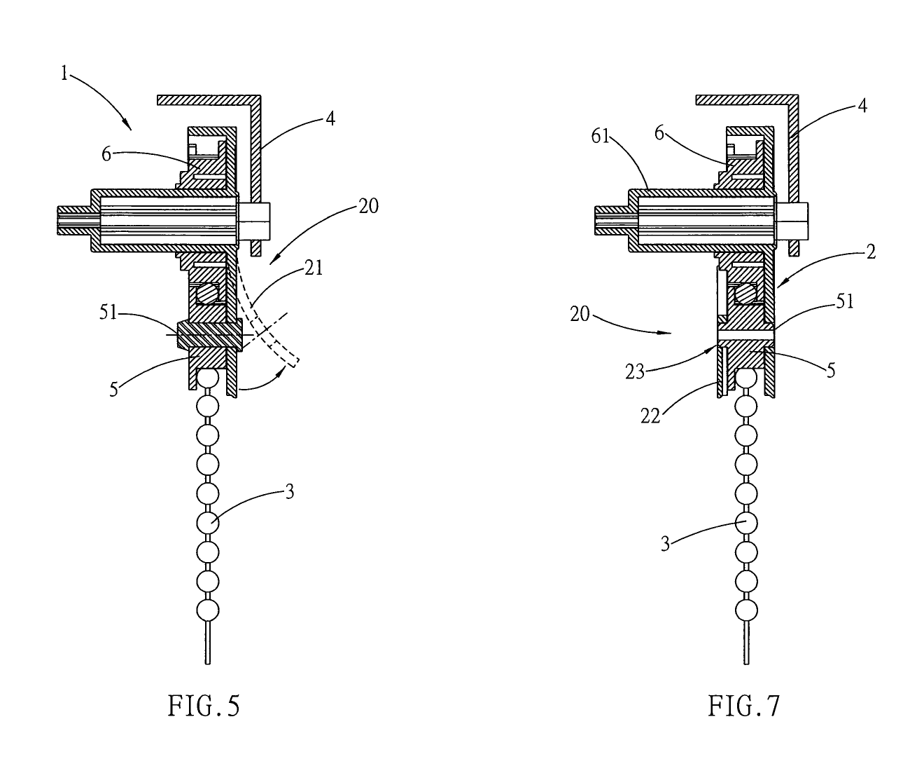

Regarding implementation and realization of the component releasing operation of the roll-up control unit 1, please first refer to FIGS. 4 and 5, wherein the roll-up control unit 1 comprises a mount 2, one side of which is fitted with the transmission shaft 61, and the transmission shaft 61 is linked to a roll-up control wheel 5 (the linkage relation can be accomplished using various means, including gear teeth meshing, friction rolling, indirect transmission belt, and so on), the roll-up control wheel 5 is controlled by the looping pulling component 3, and the motive force obtained therefrom is transmitted indirectly to a coupled wheel 6. The coupled wheel 6 then drives the curtain 100 of the window curtains set 10 to alter shading depth of a window.

The transmission shaft 61 and the roll-up control wheel 5 are connected to the mount 2 using movable pin means, and an outer end of the mount 2 is joined to a locating hole 41 defined in a bracket 4. The bracket 4 is fixed to a building structure, thereby fixedly positioning and supporting the roll-up control unit 1.

The deformation portion 20 is located at one side of the mount 2, and the deformation portion 20 comprises a deformable plate 21. When the roll-up control wheel 5 is subjected to inappropriate forces from the pulling component 3, then one end of a wheel shaft 51 produces a lever effect, and the other end, which is perpendicularly pin connected to the plate 21, causes the acting force formed by the inappropriate forces to perpendicularly affect the plate 21, thereby causing curved deformation of the plate 21, and direction of the deformation is perpendicular to the direction of the pulling force. Accordingly, deformation of the plate 21 is used to alter the originally horizontally pin disposed wheel shaft 51 which deflects downward to an outward inclination, causing eversion of the coupled wheel 5 in accordance with the leverage and component force effect, thereby enabling the pulling component 3 to jump the wheel face of the roll-up control wheel 5 and freeing the pulling component 3 therefrom, thereby further loosening and losing the entangling force on limbs at the lower ends of the pulling component 3, and ending the danger on a child, as well as maintaining safety of the child.

The plate 21 of the roll-up control unit 1 of the present invention is further provided with elastic restoring force, thereby enabling restoration thereof, and enabling a user single handed to rehang the pulling component 3 back on the roll-up control unit 1 to resume reuse thereof.

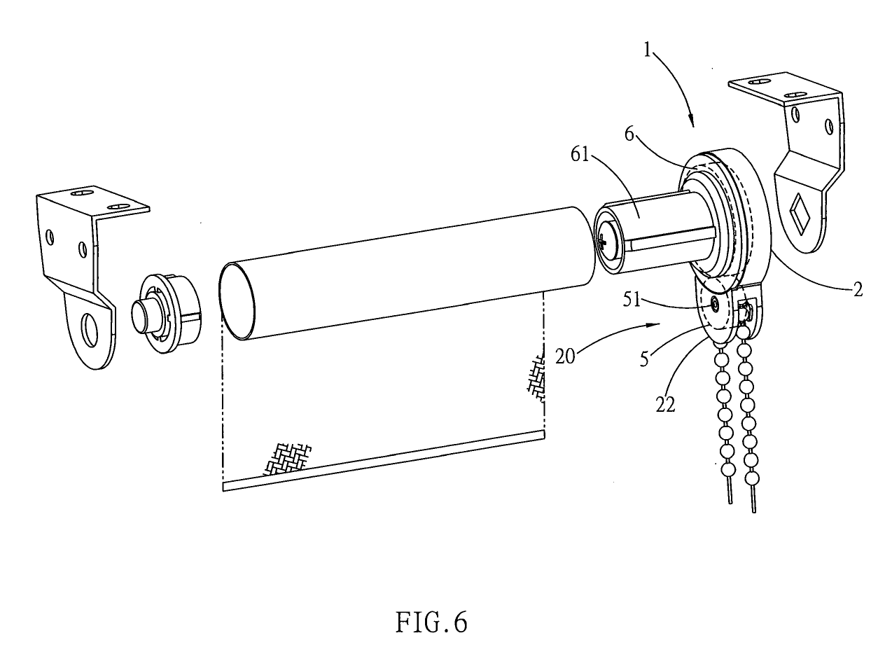

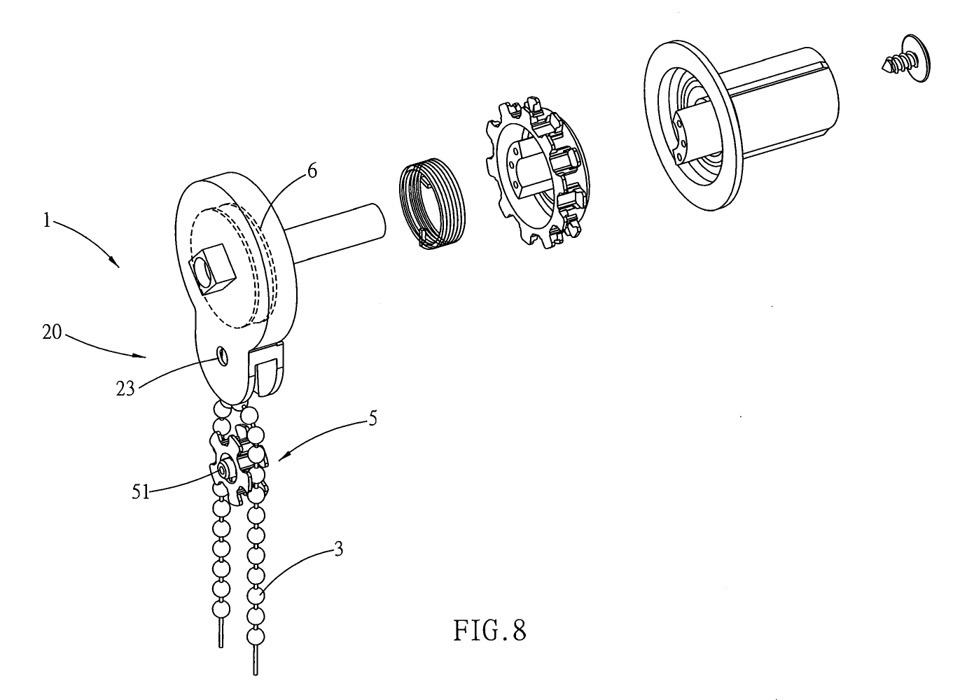

Regarding another specific embodiment of the pulling component 3 enabling separation from the roll-up control unit 1, please refer to FIGS. 6, 7 and 8, wherein separation of the pulling component 3 can also be accomplished by synchronously separating together with all connected components from the roll-up control unit 1, thereby essentially causing an action that loosens and frees the pulling component 3.

Regarding the releasing actuating mechanism which affords separation of the roll-up control wheel 5 together with the pulling component 3, an inner side of the mount 2 of the roll-up control unit 1 enables the transmission shaft 61 to be connected to the roll-up control wheel 5, and the roll-up control wheel 5 is controlled through the pulling component 3, the motive force from which is transmitted to the transmission shaft 61 by transmission means similar to the aforementioned, whereupon the transmission shaft 61 coaxially actuates the coupled wheel 6 to adjust shading depth of a window curtain.

Wherein, at least one deformable pin connected plate 22 is located at the pin connected position of the roll-up control wheel 5, and the pin connected plate 22 is provided with shaft holes 23 enabling pin disposition of the wheel shaft 51 of the roll-up control wheel 5 therein. Under normal use, the roll-up control wheel 5 adheres to the position of the shaft holes 23 and rotates in its original position. However, under circumstances whereby the roll-up control wheel 5 is subjected to inappropriate forces, then the pin connected plate 22 deforms to yield the wheel shaft 51 from spanning the length of the two ends of the roll-up control wheel 5, thereby releasing the wheel shaft 51 which together with the pulling component 3 separates from the roll-up control unit 1. Accordingly, the separating action achieves the objective of maintaining the safety of a person entangled by the pulling component 3.

Regarding deformation of the aforementioned deformation portion 20, when the pulling component 3 is subjected to inappropriate forces caused by an accident occurring as mentioned above, then pulling forces on the pulling component 3 first affect the roll-up control wheel 5, the forces then being transmitted to the mount 2 and the bracket 4. Directions of the inappropriate pulling forces seek vulnerable points to damage, however, because the bracket 4 is firmly fixed to a wall, thus fixing strength and tensile strength thereof diverts vulnerability to the deformation portion 20, and, compared to other components, the deformation portion 20 deforms in accordance with the pin connected plate 22 having an elastic deformation response that more easily responds to the forces. Moreover, the acting forces from the pulling component 3 causes the two ends of the wheel shaft 51 pin connected to the deformation portion 20 to dislodge towards the direction of the pulling forces of the pulling component 3. The two ends of the wheel shaft 51 are pin connected in a superficial fashion to a shallow depth in the shaft holes 23. Hence, the shearing stress of the wheel shaft 51 relative to the shaft holes 23 will surmount the mechanical holding force of the shaft holes 23 and force the pin connected plate 22 to deform, thereby causing the internal space thereof to yield a sufficient span to allow dissociation of the wheel shaft 51 together with the pulling component 3.

Wherein the two ends of the wheel shaft 51 or inner circular surfaces of the shaft holes 23 are matched so as to have a tapered surface pin connected relation, that is, the two ends of the wheel shaft 51 are outward oblique cones, and the inner circular surfaces of the shaft holes 23 are matching corresponding conical surfaces, thereby making it easier to obtain diagonal force components to shear stress the pin connected plate 22 and cause outward deformation thereof, and enabling separation of the pulling component 3.

The aforementioned pulling force resistance must provide the pin connected plate 22 with adequate mechanical force to effectively support maintaining a fixed position of the roll-up control wheel 5 while enabling normal operating forces on the pulling component 3, in which normal operating forces are forces that enable rolling up and letting down of curtains.

In addition, the pin connected plate 22 is provided with elastic recovery, thereby enabling reuse after recombination of components.

Regarding the aforementioned recombination, after the pulling component 3 is looped round the wheel face of the roll-up control wheel 5, then elastic deformation of the pin connected plate 22 is used to press down on the wheel shaft 51 of the roll-up control wheel 5 and force the two ends of the wheel shaft 51 to enter the shaft holes 23. Moreover, the above operations can be accomplished single handed without the need for specialized persons to recombine the components.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A window curtain safety design, having use in a window curtain set which utilizes a looping pull cord to alter shading condition of a window curtain, and which provides a safety design that prevents the dangling closed end of the pull cord from entangling the limbs, comprising:
a curtain roll-up control unit, the curtain roll-up control unit is fitted with deformation portions;
a bracket, the bracket enables assembly and fixed positioning of the roll-up control unit;
a looping pulling component, the pulling component acts on the roll-up control unit, wherein when the roll-up control unit is subjected to synchronous excessive pulling from two sides of the pulling component, then the deformation portions cause the pulling component to separate.

2. The window curtain safety design according to claim 1, wherein the roll-up control unit comprises a mount, one side of the mount is connected to a transmission shaft and a roll-up control wheel, the roll-up control wheel drives the transmission shaft through force being applied to the pulling component, and the deformation portions are elastic plates formed between the mount supported coupled wheel and the roll-up control wheel.

3. The window curtain safety design according to claim 1, wherein the roll-up control unit comprises a mount, one side of the mount is connected to the transmission shaft and the roll-up control wheel, the roll-up control wheel drives the transmission shaft through force being applied to the pulling component, and the deformation portions are formed from elastic pin connected plates extending toward another side at a lower end of the mount, the pin connected plates connect and support the roll-up control wheel.

4. The window curtain safety design according to claim 3, wherein shaft holes of the pin connected plates and a wheel shaft of the roll-up control wheel are in a conical surface, pin connected relation.
